(19) United States
(12) Patent Application Publication
(10) Pub. No.: US 2011/0179627 A1
(43) Pub. Date: Jul. 28, 2011

(54) WORKPIECE ASSEMBLING METHOD

(75) Inventors: Toshiyuki Kondo, Tochigi-ken (JP); Kenichi Ohno, Utsunomiya-shi (JP)

(73) Assignee: HONDA MOTOR CO., LTD., Tokyo (JP)

(21) Appl. No.: 13/015,164

(22) Filed: Jan. 27, 2011

(30) Foreign Application Priority Data
Jan. 28, 2010 (JP) 2010-016096

(51) Int. Cl. B23P 11/00

(52) U.S. Cl. 29/430

(57) ABSTRACT

A workpiece assembling method uses an assembly work cell, the assembly work cell including: a worker station at which a worker works; an apparatus station at which an apparatus works; and a transfer unit that transfers a workpiece to be processed between the worker station and the apparatus station. In the method, the workpiece to be processed is alternately moved by the transfer unit between the worker station and the apparatus station, so that the worker and the apparatus alternately assemble the workpiece.

### CROSS-REFERENCE TO RELATED APPLICATION

This application is based upon and claims the benefit of priority from Japanese Patent Application No. 2010-016096 filed on Jan. 28, 2010, of which the contents are incorporated herein by reference.

### BACKGROUND OF THE INVENTION

1. Field of the Invention

The present invention relates to a workpiece assembling method for assembling a workpiece by a cooperative work of a worker and a robot.

2. Description of the Related Art

In an assembly line of an automobile, a worker and a robot have heretofore cooperated to assemble components of automobiles in order to improve production efficiency.

Japanese Laid-Open Patent Publication No. 2001-219322 discloses an assembly apparatus having a component supply station in which a worker works and a component assembly station in which a robot works. Specifically, a worker sets a plurality of components on a palette and places the palette on a belt conveyor in the component supply station. The belt conveyor then conveys the palette to the component assembly station in which the robot assembles the components set on the palette. Thus, the component can be reliably assembled while avoiding component jamming at the component supply station, thus improving operation availability of the apparatus.

In general, a robot is often not good at gripping a soft material. Accordingly, a work available for a robot is restricted to simple tasks such as fastening, clip insert and the like. Thus a cooperative work of a robot and a worker is sometimes required for assembling workpiece depending on the nature of the workpiece. Further, since assembling order of a workpiece is determined in advance, subsequent step can be conducted only after assembling a predetermined component. Thus, the workpiece has to be assembled by alternate works of a worker and a robot. Accordingly, a plurality of robots conducting the same work such as component fastening have been required on a conventional assembly line, which increased facility cost for the robots. In addition, the robots occupy a large space.

### SUMMARY OF THE INVENTION

The invention has been reached in order to solve the above problems. An object of the invention is to provide a workpiece assembly method that requires less facility cost and less occupation space, and consequently reduces production cost.

In order to achieve the above object, a workpiece assembling method according to an aspect of the invention uses an assembly work cell, the assembly work cell including: a worker station at which a worker works; an apparatus station at which an apparatus works; and a transfer unit that transfers a workpiece to be processed between the worker station and the apparatus station, the method including: alternately moving by the transfer unit the workpiece to be processed between the worker station and the apparatus station, so that the worker and the apparatus alternately assemble the workpiece.

In the above aspect of the invention, the workpiece is preferably assembled by a plurality of assembly steps, and when one of the plurality of assembly steps is completed in the assembly work cell, the workpiece to be processed is preferably transferred to another assembly work cell by the transfer unit.

In the above aspect of the invention, the workpiece is preferably assembled by a plurality of assembly steps, each of the assembly steps includes a plurality of sub-steps, and one of the sub-steps that is capable of being done by the apparatus and is conducted for a plurality of times in assembling the workpiece is preferentially assigned to the apparatus in order of frequency of the sub-steps.

In the above aspect of the invention, workpieces that outnumber the sum of the worker station and the apparatus station are preferably concurrently assembled in the assembly work cell.

According to the above aspect of the invention, since the transfer unit alternately moves the workpiece to be processed between the worker station and the apparatus station so that the worker and the apparatus alternately assemble the workpiece, the number of the apparatus and the worker can be reduced, and consequently, the production cost can be reduced. Further, even when the assembly process, the workpiece itself or the number of the workpieces to be assembled is changed, it is only necessary to alter the steps and work sequence of the assembly work cell. Accordingly, various types and quantity of workpiece can be produced without reorganizing the production line.

The workpiece is assembled by an assembly process including a plurality of assembly steps. After one of the assembly steps is completed in the assembly work cell, the workpiece is transferred to another assembly work cell. Accordingly, the workpiece to be processed goes round in the assembly work cell for plural times until the one of the assembly steps is completed, thereby conducting the one of the plurality of assembly steps of the entire assembly process in the assembly work cell.

Since the sub-steps assigned to the apparatus are determined preferentially among the sub-steps that can be done by the apparatus and are conducted for a plurality of times in assembling the workpiece in order of frequency of the sub-steps. Accordingly, the efficiency of the assembly process can be enhanced. Further, the number of the apparatus that conduct the sub-step conducted for a plurality of times can be reduced.

In the above aspect of the invention, since the workpieces that outnumber the sum of the worker station and the apparatus station are concurrently assembled in the assembly work cell, the idle time in the respective stations can be reduced and the efficiency of the assembly process of the workpiece can be enhanced.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 illustrates an arrangement of a workpiece assembly system for implementing a workpiece assembling method of the invention;

FIG. 2 schematically illustrates an arrangement of a carriage shown in FIG. 1;

FIG. 3 is a schematic perspective view that shows an assembly work cell that has a worker station and an apparatus station;

FIG. 4 illustrates a work sequence for assembling an automobile power-supply unit (a component of an automobile) using the assembly work cell shown in FIG. 3;

FIG. 5 illustrates a workflow of a worker and a robot in assembling an automobile power-supply unit by the assembly work cell shown in FIG. 3 in accordance with the work sequence shown in FIG. 4;

FIG. 6 illustrates a sub-step 2 in the work sequence shown in FIG. 4;

FIG. 7 illustrates a sub-step 4 in the work sequence shown in FIG. 4;

FIG. 8 illustrates a workflow of a worker and a robot in concurrently assembling three automobile power-supply units by the assembly work cell shown in FIG. 3 in accordance with the work sequence shown in FIG. 4;

FIG. 9 illustrates a workflow of a worker and a robot in concurrently assembling workpiece A, workpiece B and workpiece C by the assembly work cell shown in FIG. 3;

FIG. 10 is a perspective view schematically showing an assembly work cell having two worker stations and an apparatus station; and

FIG. 11 is a perspective view schematically showing an assembly work cell having a worker station and two apparatus stations.

### DESCRIPTION OF THE PREFERRED EMBODIMENTS

A workpiece assembling method and associated workpiece assembly system according to the invention will be described in detail below with reference to the attached drawings.

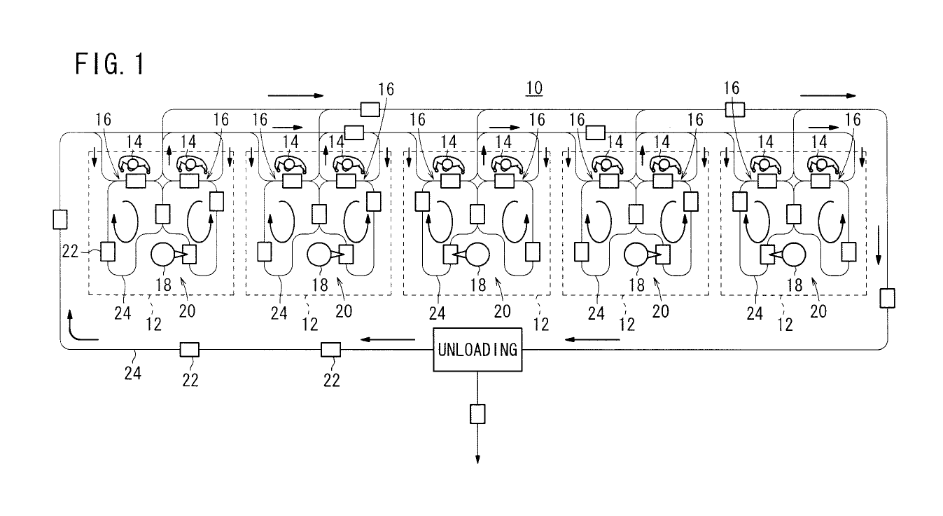

FIG. 1 illustrates an arrangement of a workpiece assembly system 10 according to an exemplary embodiment of the invention. The workpiece assembly system 10 has a plurality of assembly work cells 12 on an assembly line. The respective assembly work cells 12 are connected by rails 24 with each other. Each of the assembly work cells 12 includes a worker station 16 in which a worker (human) 14 works and an apparatus station 20 in which a robot (apparatus) having a multi-axis multi-joint arm operates. The reference numeral 22 denotes a carriage. A workpiece to be processed is placed on the carriage 22. The carriage 22 moves in the workpiece assembly system 10 along the rails 24. The workpiece to be processed refers to an interim product until a final workpiece (completed product) is completely assembled.

The workpiece assembly process includes a plurality of assembly steps. One of the assembly steps is conducted by each of the assembly work cells 12. Each of the assembly steps includes a plurality of assembly sub-steps. After completing an assembly step in one of the assembly work cells 12, the carriage 22 moves to another assembly work cell 12 to transfer the workpiece to be processed. In other words, until one of the assembly steps in one of the assembly work cells 12 is completed, the workpiece to be processed is not transferred to the other one of the assembly work cells 12. The carriage 22 moves to respective one of the assembly work cells 12 in accordance with the work sequence of the workpiece. The carriage 22 and the rail 24 serve as a transfer unit of the present invention.

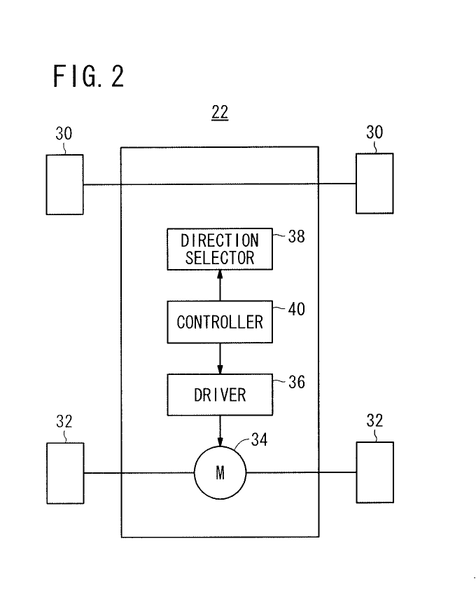

FIG. 2 schematically illustrates an arrangement of the carriage 22. The carriage 22 includes: front tires 30; rear tires 32; a motor 34 for driving the rear tires 32; a driver 36 for driving the motor 34; a direction selector 38 for commanding a direction for the carriage 22 to go when the rail 24 is branched; and a controller (computer) 40 for controlling the driver 36 and the direction selector 38. The controller 40 of the carriage 22 controls the driver 36 and the direction selector 38 under the control of a control device (computer: not shown). The control device has a storage storing the steps and work sequence of the assembly process of the workpiece and controls the controller 40 of the carriage 22 so that the carriage 22 is moved in accordance with the stored steps and the work sequence. The control device may be installed respectively in the carriages 22. Alternatively, the control device may remotely control the carriage 22 via a radio communication. Further, though the arrangement of the robot 18 is not illustrated, the robot 18 has a controller for controlling the movement of the arm and a storage storing the steps and work sequence of the assembly process of the workpiece. The controller of the robot 18 controls the multi-axis multi-joint arm in accordance with the stored steps and the work sequence to effect the operation of the robot 18.

Though the assembly work cell 12 shown in FIG. 1 has the two worker stations 16 and one apparatus station 20, the assembly work cell 12 may have one worker station 16 and one apparatus station 20 or, alternatively, may have one worker station 16 and two apparatus stations 20. In other words, the number of the worker station 16 and the apparatus station 20 provided in the assembly work cell 12 may be altered as desired. The number of the worker station 16 and the apparatus station 20 may be varied for each of the assembly work cells 12.

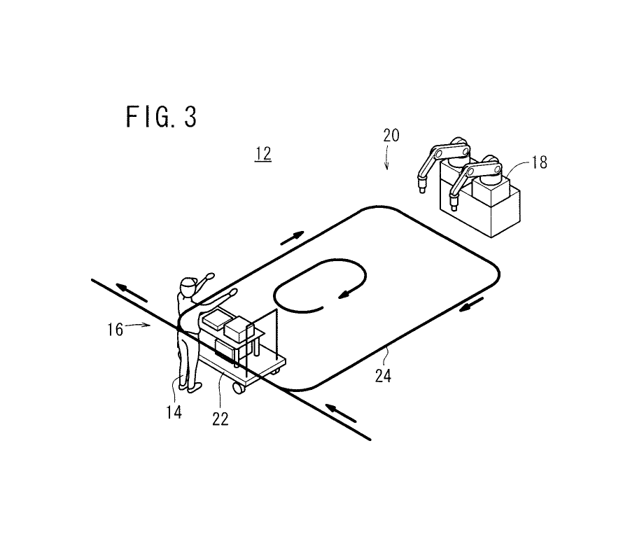

FIG. 3 is a perspective view schematically showing the assembly work cell 12 having one worker station 16 and one apparatus station 20. The rail 24 is laid in the assembly work cell 12 so that the carriage 22 can go round the worker station 16 and the apparatus station 20. Thus, the carriage 22 is capable of alternately moving along the rail 24 between the worker station 16 and the apparatus station 20, so that the worker 14 at the worker station 16 and the robot 18 at the apparatus station 20 are capable of alternately assembling the workpiece.

Specifically, when the worker 14 completes his/her work, the carriage 22 moves to the apparatus station 20 at which the robot 18 is stationed. After the robot 18 completes its work, the carriage 22 moves again to the worker station 16 at which the worker 14 is stationed. Thus, by the alternate plurality of works by the worker 14 and the robot 18, the workpiece can be assembled by both of the worker 14 and the robot 18. Incidentally, when the one of the assembly steps is completed, the carriage 22 moves to another assembly work cell 12 to transfer the workpiece to be processed. Then, the next assembly step is conducted by the subsequent assembly work cell 12 to which the workpiece to be processed is transferred.

The sub-step assigned to the robot 18 may be preferentially determined among the sub-steps that can be done by the robot 18 and are conducted for a plurality of times during the entire assembly process of the workpiece or the assembly steps done in the assembly work cell 12 (a part of the assembly process of the workpiece) in order of the frequency of the sub-steps. Since the number of available robots 18 is limited, assignment of works that are done for a small number of times to the robot 18 results in increase in the work time of the worker. Accordingly, the work that is done more frequently may advantageously be assigned to the robot 18.

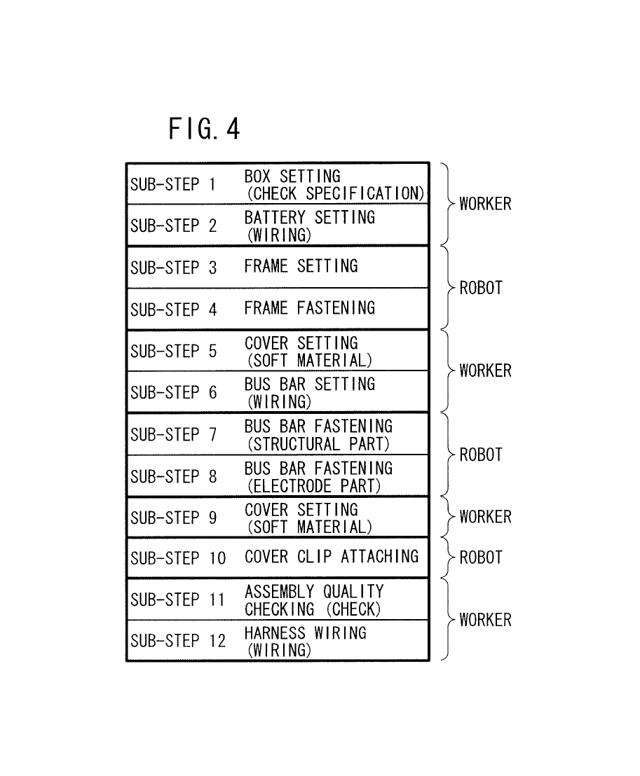

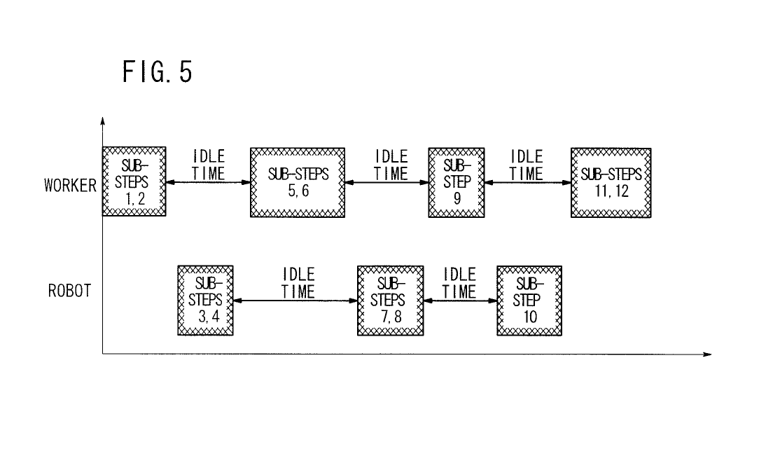

FIG. 4 illustrates a work sequence for assembling an automobile power-supply unit (a component of an automobile) using the assembly work cells 12 shown in FIG. 3. FIG. 5 illustrates a workflow of the worker 14 and the robot 18 in assembling the automobile power-supply unit by the assembly work cell shown in FIG. 3 in accordance with the work sequence shown in FIG. 4.

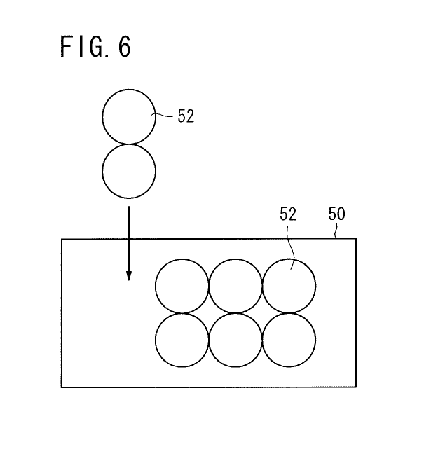

Initially, the carriage 22 is moved to the worker station 16 and is stopped at a first position at which the worker 14 stands. The worker 14 conducts the sub-steps 1 and 2. The sub-step 1 is for setting a box of the automobile power-supply unit after checking the specification of the automobile power-supply unit. Since the specification has to be checked, the sub-step 1 is a human labor. In the sub-step 2, as shown in FIG. 6, cylindrical batteries 52 are set in a box 50 and are mutually wired. Since the robot 18 is unable to do delicate works such as wiring, the batteries 52 are manually wired. Here, the box 50 having the batteries 52 is the workpiece to be processed.

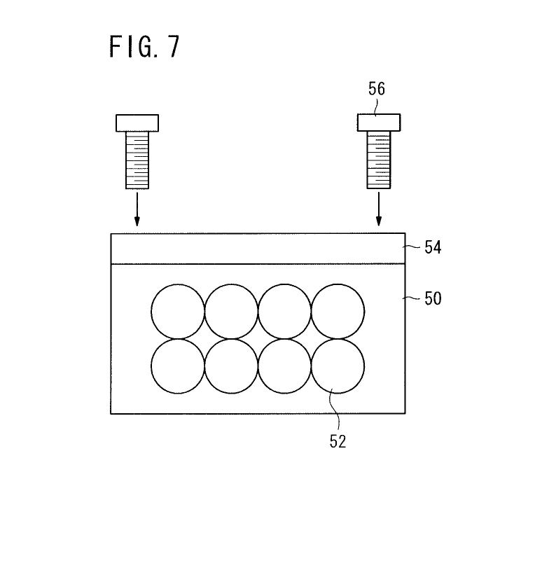

After completing the sub-steps 1 and 2, the carriage 22 is moved to the apparatus station 20 and is stopped at a second position at which the robot 18 is stationed. The robot 18 conducts the sub-steps 3 and 4. The sub-step 3 is for setting a frame 54 on the box 50. The sub-step 4 is for fastening the frame 54 by securing members 56 such as screws and bolts to fix the frame 54 on the box 50 as shown in FIG. 7. Since the sub-steps 3 and 4 can be done by the robot 18, the sub-steps are assigned to the robot 18. Here, the box 50 fastened with the frame 54 is the workpiece to be processed.

When the sub-steps 3 and 4 are completed, the carriage 22 is moved to the worker station 16 and is stopped at the first position at which the worker 14 stands. The worker 14 conducts the sub-steps 5 and 6. The sub-step 5 is for setting a cover of a soft material. The sub-step 6 is for setting a bus bar (not shown) between the batteries 52 for wiring. Since the sub-steps 5 and 6 cannot be done by the robot 18, the sub-steps are assigned to the worker 14.

After completing the sub-steps 5 and 6, the carriage 22 is moved to the apparatus station 20 and is stopped at the second position at which the robot 18 is stationed. The robot 18 conducts the sub-steps 7 and 8. The sub-step 7 is for fastening structural parts of the bus bar. The sub-step 8 is for fastening electrode parts of the bus bar. Since the sub-steps 7 and 8 can be done by the robot 18, the sub-steps are assigned to the robot 18.

After completing the sub-step 8, the carriage 22 is moved to the first position of the worker station 16, at which the worker 14 conducts the sub-step 9. The sub-step 9 is for further setting the cover of the soft material. Since the sub-step 9 cannot be done by the robot 18, the sub-step 9 is assigned to the worker 14.

After completing the sub-step 9, the carriage 22 is moved to the second position of the apparatus station 20, at which the robot 18 conducts the sub-step 10. The sub-step 10 is for attaching a cover clip to the batteries 52 to fix the cover set in the sub-step 9. Since the sub-steps 10 can be done by the robot 18, the sub-step 10 is assigned to the robot 18.

After the sub-step 10 is completed, the carriage 22 is moved to the first position of the worker station 16, at which the worker 14 conducts sub-steps 11 and 12. The sub-step 11 is for checking an assembly quality. The sub-step 12 is for wiring a harness to the assembled automobile power-supply unit. Since the sub-steps 11 and 12 cannot be done by the robot 18, the sub-steps 11 and 12 are assigned to the worker 14.

After completing the sub-steps 11 and 12, the carriage 22 is moved to the other assembly work cell 12 to transfer the workpiece to be processed to the other assembly work cell 12.

As described above, by alternately moving the workpiece to be processed between the worker station 16 and the apparatus station 20 in the single assembly work cell 12, the workpiece can be alternately assembled by the worker 14 and the robot 18, so that the number of the worker 14 and the robot 18 can be reduced, and consequently, the production cost can be reduced. Further, an entirety of the assembly step can be conducted in the single assembly work cell 12.

Incidentally, it should be understood that the movement of the carriage 22 and the procedure of the robot 18 are controlled according to the work sequence commanded by the control device (not shown). The control device may judge that the worker 14 and the robot 18 complete his/its work when the control device receives a signal from the carriage 22 indicating that a button provided on the carriage 22 is pressed by the worker 14 or the robot 18. Specifically, when the button provided on the carriage 22 is pressed down, a press-down signal indicating that the button is pressed is sent to the control device. When the control device receives the press-down signal, judging that the sub-step of the worker 14 or the robot 18 is completed, the control device moves the carriage 22. For instance, when the worker 14 completes the sub-steps 1 and 2 and the worker 14 presses down the button provided on the carriage 22, the carriage 22 is moved to the apparatus station 20.

Alternatively, an operation time of the respective sub-steps may be determined in advance and the control device may judge that the work of the worker 14 and the robot 18 is completed based on a judgment whether the operation time corresponding to the current sub-step has been lapsed or not. For instance, if the operation time of the sub-steps 1 and 2 is determined as 15 seconds, when the sub-steps 1 and 2 are done at the worker station 16 and 15 seconds have passed after the carriage 22 stops at the worker station 16, the carriage 22 may be automatically moved to the apparatus station 20 judging that the sub-steps 1 and 2 are completed.

As can be easily understood in view of FIG. 5, when only one assembly step is conducted in the assembly work cell 12, excessive idle time at which the worker 14 and the robot 18 are not working is caused and the work efficiency is impaired. Accordingly, a plurality of the carriages 22 are advantageously employed in the assembly work cell 12 to concurrently conduct assembly sub-steps of a plurality of the workpiece. At this time, since idling time of the worker 14 and the robot 18 is caused when the number of the workpieces to be assembled in the single assembly work cell 12 is smaller than the sum of the worker station 16 and the apparatus station 20 in the assembly work cell 12, it is preferable that the number of the workpiece is larger than the sum of the worker station 16 and the apparatus station 20 in the assembly work cell 12.

For instance, when two workpieces are assembled in the assembly work cell 12 shown in FIG. 3 (i.e. when the same number of the workpieces as the sum of the worker station 16 and the apparatus station 20 are assembled in the assembly work cell 12), though the worker 14 works while the robot 18 is working, the worker 14 and the robot 18 have to suspend their works while the workpiece to be processed is transferred from the worker station 16 to the apparatus station 20 and from the apparatus station 20 to the worker station 16.

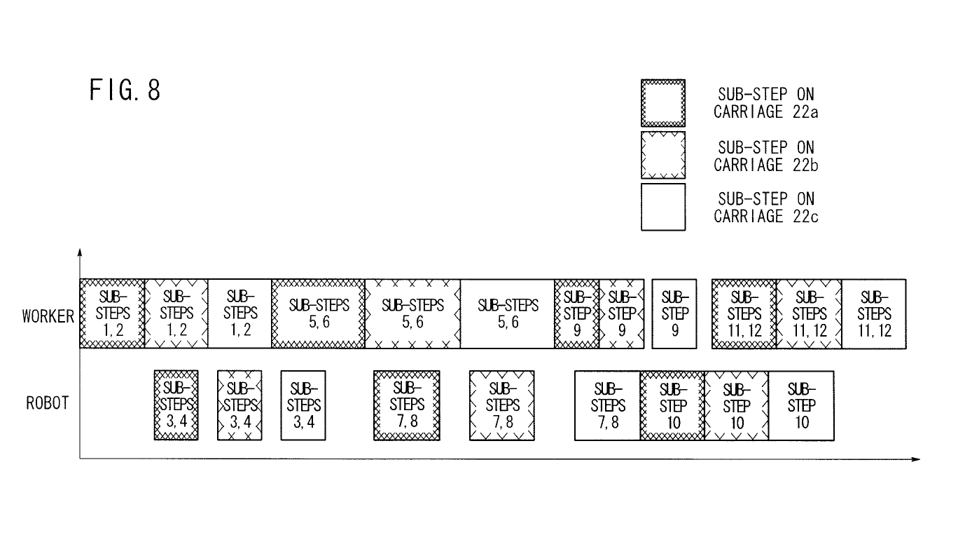

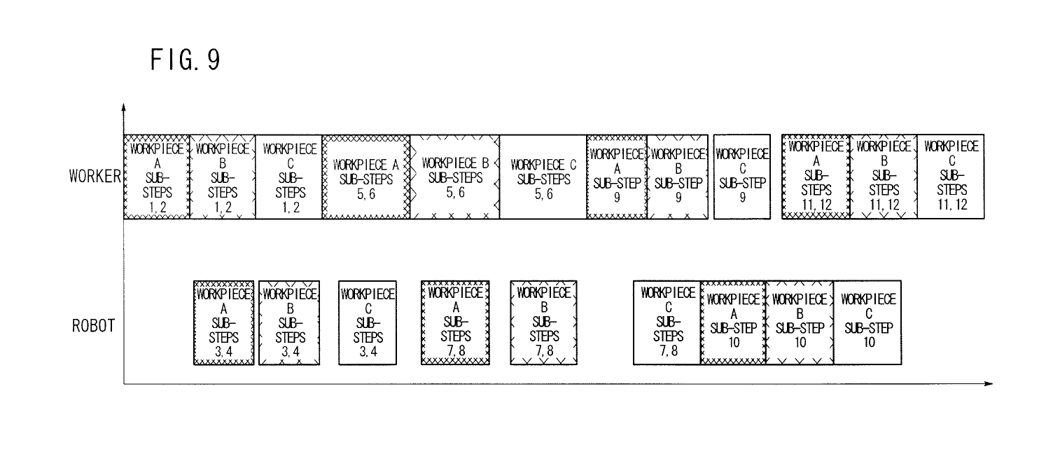

FIGS. 8 and 9 illustrate workflows of the worker 14 and the robot 18 when more than the sum (i.e. sum of the worker station 16 and the apparatus station 20 of the assembly work cell 12 shown in FIG. 3) of the workpieces are concurrently assembled. FIG. 8 illustrates a workflow of the worker 14 and the robot 18 when three automobile power-supply units are concurrently assembled in accordance with the work sequence shown in FIG. 4. Here, the carriage 22 used for assembling the first automobile power-supply unit is referred to as a carriage 22a. The carriage 22 used for assembling the second automobile power-supply unit is referred to as a carriage 22b. The carriage 22 used for assembling the third automobile power-supply unit is referred to as a carriage 22c. In FIG. 8, the sub-step framed in dense cross lines represents a sub-step on the carriage 22a, the sub-step framed in coarse cross lines represents a sub-step on the carriage 22b and the sub-step framed without cross lines represents a sub-step on the carriage 22c.

Initially, when the carriage 22a is moved to the first position of the worker station 16, the worker 14 conducts the sub-steps 1 and 2 on the carriage 22a. When the sub-steps on the carriage 22a are completed, the carriages 22a is moved to the second position of the apparatus station 20 and the carriage 22b is moved to the first position of the worker station 16. The worker 14 conducts the sub-steps 1 and 2 on the carriage 22b, while the robot 18 conducts the sub-steps 3 and 4 on the carriage 22a.

Subsequently, when the robot 18 completes the sub-steps on the carriage 22a, the carriage 22a is moved toward the worker station 16. Similarly, when the worker 14 completes the sub-steps on the carriage 22b, the carriage 22b is moved to the second position of the apparatus station 20. At this time, the carriage 22a is controllably moved so that the carriage 22a is not moved to the first position of the worker station 16 before the carriage 22c arrives. When the carriage 22c is moved to the first station of the worker station 16, the worker 14 conducts the sub-steps 1 and 2 on the carriage 22c. Further, when the carriage 22b is moved to the apparatus station 20, the robot 18 conducts the sub-steps 3 and 4 on the carriage 22b. Subsequently, the carriage 22c is moved from the worker station 16 to the second position of the apparatus station 20 while the carriage 22b is moved from the apparatus station 20 to the worker station 16. Further, the carriage 22a is moved to the first position of the worker station 16 before the carriage 22b arrives.

As described above, the carriages 22a, 22b and 22c are alternately moved between the worker station 16 and the apparatus station 20 in the order of the carriage 22a, the carriage 22b and the carriage 22c, so that the worker 14 and the robot 18 can alternately assemble the workpiece in the assembly work cell 12.

Thus, the number of the worker 14 and the robot 18 can be reduced, thereby reducing the production cost. Further, since the plurality of the workpieces that outnumber the sum of the worker station 16 and the apparatus station 20 are concurrently assembled in the assembly work cell 12, the idle time in the respective stations can be reduced, thereby enhancing the efficiency of the workpiece assembly process.

FIG. 9 illustrates a workflow of the worker 14 and the robot 18 when the workpiece A, workpiece B and workpiece C are concurrently assembled in the assembly work cell 12 shown in FIG. 3. Briefly explaining the workflow shown in FIG. 9, the worker 14 initially conducts the sub-steps 1 and 2 on the workpiece A. After the sub-steps 1 and 2 on the workpiece A are completed, the robot 18 conducts the sub-steps 3 and 4 on the workpiece A while the worker 14 conducts the sub-steps 1 and 2 on the workpiece B. When the respective sub-steps of the worker 14 and the robot 18 are completed, the worker 14 conducts the sub-steps 1 and 2 on the workpiece C while the robot 18 conducts the sub-steps 3 and 4 on the workpiece B. After the respective sub-steps are completed, the worker 14 conducts the sub-steps 5 and 6 on the workpiece A and the robot 18 conducts the sub-steps 3 and 4 on the workpiece C. It should be understood that the three carriages 22 used for assembling the workpiece A, workpiece B and workpiece C alternately move between the worker station 16 and the apparatus station 20 under the control of the above-described control device. The robot 18 also assembles the workpiece A, workpiece B and workpiece C in accordance with the work sequence.

As described above, since the worker 14 and the robot 18 alternately assembles the workpiece in the assembly work cell 12, the number of the worker 14 and the robot 18 can be reduced, and consequently, the production cost can be reduced. Further, since the plurality of the workpieces that outnumber the sum of the worker station 16 and the apparatus station 20 are concurrently assembled in the assembly work cell 12, the idle time in the respective stations can be reduced, thereby enhancing the efficiency of the workpiece assembly process.

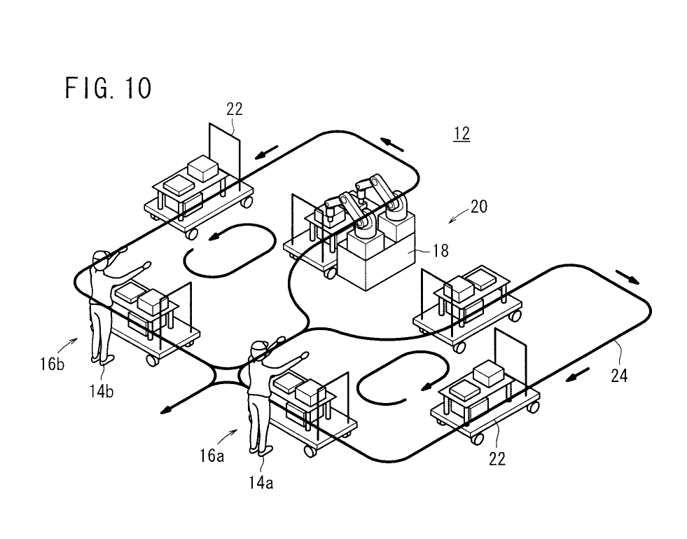

FIG. 10 is a perspective view schematically showing the assembly work cell 12 having two worker stations 16 and a single apparatus station 20. Since the two worker stations 16 are shown in FIG. 10, one of the worker stations 16 is represented by 16a while the other one of the worker stations 16 is represented by 16b. Further, the worker 14 stationed at the worker station 16a is represented by 14a and the worker 14 stationed at the worker station 16b is represented by 14b. In FIG. 10, six carriages 22 that outnumber the sum of the worker stations 16 and the apparatus station 20 are moving round in the assembly work cell 12 so that six workpieces can be concurrently assembled.

In the assembly work cell 12, the rail 24 that enables the carriages 22 to move round freely between the worker stations 16a and 16b and the apparatus station 20 is laid. Thus, the carriages 22 can move alternately between the worker stations 16a and 16b and the apparatus station 20 along the rail 24, so that the workers 14a and 14b and the robot 18 can alternately assemble the workpiece. Since the carriages 22 are moved from the worker stations 16a and 16b to the apparatus station 20, the robot 18 conducts its work on the carriages 22 transferred from the worker stations 16a and 16b.

The carriages 22 are moved from the worker stations 16a and 16b to the apparatus station 20 and are also moved from the apparatus station 20 to one of the worker stations 16a and 16b. For instance, one of the carriages 22 is adapted to be alternately moved between one of the worker stations 16 and the apparatus station 20 (e.g. from the worker station 16a to the apparatus station 20 and again to the worker station 16a). Alternatively, one of the carriages 22 may be adapted to be alternately moved between both of the worker stations 16 and the apparatus station 20 (e.g. from the worker station 16a to the apparatus station 20 and further to the worker station 16b). The movement order of the carriage 22 is determined according to the work sequence under the control of the above-described control device. Further, the robot 18 also conducts its work in accordance with the work sequence.

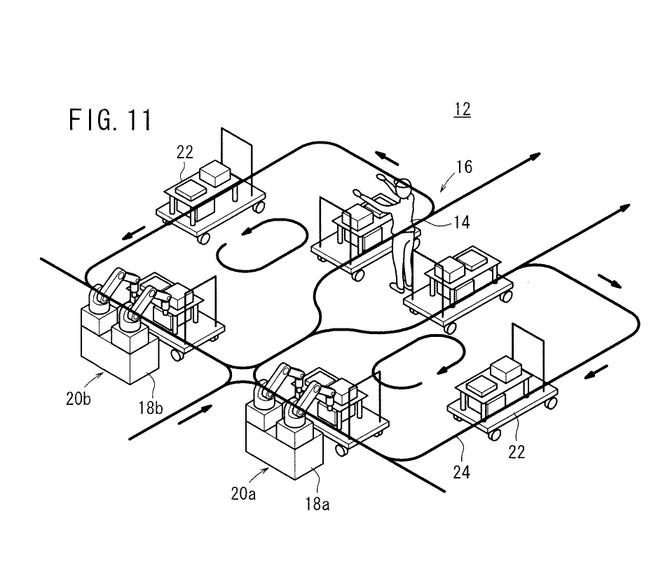

FIG. 11 is a perspective view schematically showing the assembly work cell 12 having one worker station 16 and two apparatus stations 20. In FIG. 11, since the two apparatus stations 20 are provided, one of the apparatus stations 20 is represented by 20a and the other one of the apparatus stations 20 is represented by 20b. Further, the robot 18 stationed at the apparatus station 20a is represented by 18a and the robot 18 stationed at the apparatus station 20b is represented by 18b. In FIG. 11, six carriages 22 that outnumbers the sum of the worker station 16 and the apparatus stations 20 are moving round in the assembly work cell 12 so that six workpieces can be concurrently assembled.

The rail 24 is laid in the assembly work cell 12 so that the carriages 22 can go round the worker station 16 and the apparatus stations 20a and 20b. Accordingly, the carriages 22 can alternately move between the worker station 16 and the apparatus stations 20a and 20b, so that the worker 14 and the robots 18a and 18b can alternately assemble the workpiece. Since the carriages 22 are moved from the apparatus stations 20a and 20b to the worker station 16, the worker 14 conducts the sub-steps on the carriages 22 transferred from the apparatus stations 20a and 20b.

The carriages 22 are moved from the apparatus stations 20a and 20b to the worker station 16 and are moved from the worker station 16 to one of the apparatus stations 20a and 20b. For instance, the carriages 22 are adapted to be alternately moved between one of the apparatus stations 20 and the worker station 16 (e.g. from the apparatus station 20a to the worker station 16 and again to the apparatus station 20a). Alternatively, the carriages 22 are also adapted to be moved between the two apparatus stations 20 and the worker station 16 (e.g. from the apparatus station 20a to the worker station 16 and further to the apparatus station 20b). The order of the movement of the carriages is determined in accordance with the work sequence under the control of the above-described control device. Further, the robot 18 also conducts its sub-steps in accordance with the work sequence.

As described above, the carriage(s) 22 on which the workpiece to be processed is mounted alternately moves between the worker station(s) 16 and the apparatus station(s) 20 in the assembly work cell 12 having the worker station 16 at which the worker 14 works and the apparatus station 20 at which the robot 18 works. Accordingly, the worker 14 and the robot 18 can alternately assemble the workpiece, so that the number of the worker 14 and the robot 18 can be reduced, and consequently, the production cost of a product can be reduced. Further, a conventional production line has to be redesigned in accordance with a change in the assembly process, the workpiece or the number of the workpieces to be assembled. However, with the use of the assembly work cell 12, the above change (e.g. change in the type and quantity) can be addressed only by altering the sub-steps and work sequence of the assembly process of the assembly work cell 12 without requiring reorganization of the production line.

The exemplary embodiments of the invention have been described above. However, it should be noted that the technical scope of the invention is not limited to the above exemplary embodiments. It is clear to those skilled in the art to make various modifications or improvements to the above-described exemplary embodiments. Any embodiment bearing such modifications or improvements can be included in the technical scope of the invention as mentioned in the claims below.

What is claimed is:

1. A workpiece assembling method using an assembly work cell, the assembly work cell comprising:
a worker station at which a worker works;
an apparatus station at which an apparatus works; and
a transfer unit that transfers a workpiece to be processed between the worker station and the apparatus station, the method comprising:
alternately moving by the transfer unit the workpiece to be processed between the worker station and the apparatus station, so that the worker and the apparatus alternately assemble the workpiece.

2. The workpiece assembling method according to claim 1, wherein the workpiece is assembled by a plurality of assembly steps, and
when one of the plurality of assembly steps is completed in the assembly work cell, the workpiece to be processed is transferred to another assembly work cell by the transfer unit.

3. The workpiece assembling method according to claim 1, wherein the workpiece is assembled by a plurality of assembly steps, each of the assembly steps includes a plurality of sub-steps, and one of the sub-steps that is capable of being done by the apparatus and is conducted for a plurality of times in assembling the workpiece is preferentially assigned to the apparatus in order of frequency of the sub-steps.

4. The workpiece assembling method according to claim 1, wherein workpieces that outnumber the sum of the worker station and the apparatus station are concurrently assembled in the assembly work cell.
